(19) United States
(12) Patent Application Publication
(10) Pub. No.: US 2026/0211879 A1
(43) Pub. Date: Jul. 23, 2026

(54) ESTIMATING DEGREE OF PARALLELISM IN DISTRIBUTED QUERY EXECUTION

(71) Applicant: Snowflake Inc., Bozeman, MT (US)

(72) Inventors: Hossein Ahmadi, Seattle, WA (US); Eric Chiu, San Francisco, CA (US); Thierry Cruanes, San Mateo, CA (US); Varun Ganesh, San Bruno, CA (US); Lukas A. Lorimer, San Mateo, CA (US); Yi Pan, San Jose, CA (US)

(21) Appl. No.: 19/031,226

(22) Filed: Jan. 17, 2025

(51) Int. Cl. G06F 16/2453

(52) U.S. Cl. CPC G06F 16/24532; G06F 16/24542

(57) ABSTRACT

Optimal degree of parallelism (DOP) can improve query execution performance. An execution plan to execute the query may be generated, the execution plan comprising a plurality of operators and links. The execution plan may be decomposed into a plurality of sequences of connected operators of the plurality of operators. For each sequence, a set of input values may be determined, and a per-sequence optimal DOP value and a per-sequence minimum DOP value may be generated based on the set of input values for the respective sequence.

### TECHNICAL FIELD

The present disclosure generally relates to data systems, and, more specifically, mechanisms for estimating optimal degree of parallelism (DOP) in distributed query execution.

### BACKGROUND

As the world becomes more data driven, database systems and other data systems are storing more and more data. For a business to use this data, different operations or queries are typically run on this large amount of data. Some operations, for example those including large table scans or executing multiple queries, can take a substantial amount of time to execute on a large amount of data. Typically, the time to execute such operations can be proportional to the number of computing resources used for execution, so time can be shortened using more computing resources. However, determining the number of computing resources can be difficult.

### BRIEF DESCRIPTION OF THE DRAWINGS

Various ones of the appended drawings merely illustrate example embodiments of the present disclosure and should not be considered as limiting its scope.

FIG. 1 illustrates an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a simplified block diagram of a data system architecture for job scheduling in a data system, according to some example embodiments.

FIG. 5 is a simplified block diagram of an adaptive warehouse framework, according to some example embodiments.

FIG. 6 is a simplified block diagram of framework for DOP estimation, according to some example embodiments.

FIG. 7 is a flow diagram of a method for estimating DOP for a query, according to some example embodiments.

FIG. 8 is a flow diagram of a method for refining a DOP estimate, according to some example embodiments.

FIG. 9 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

As mentioned above, determining a number of computing resources for executing queries can be difficult. Some systems attempt to determine the degree of parallelism (DOP), which is a metric that indicates the number of operations that a computing system can perform simultaneously. However, inaccurate estimates of DOPs can have adverse impacts on the performance of the data system. For example, overestimating the DOP can lead to underutilization of clusters and can introduce additional run-time overhead, reducing overall execution efficiency and execution time of queries. Underestimating the DOP can lead to query failures or slow query execution times.

Techniques for estimating the optimal DOP for a workload, such as a query, at compile time are described. As described in further detail below, the DOP estimation may be performed within the compiler with no input from a warehouse scheduler. In some embodiments, the DOP estimation may not be dependent on warehouse limits or the current state of the warehouse (e.g., active clusters and queries).

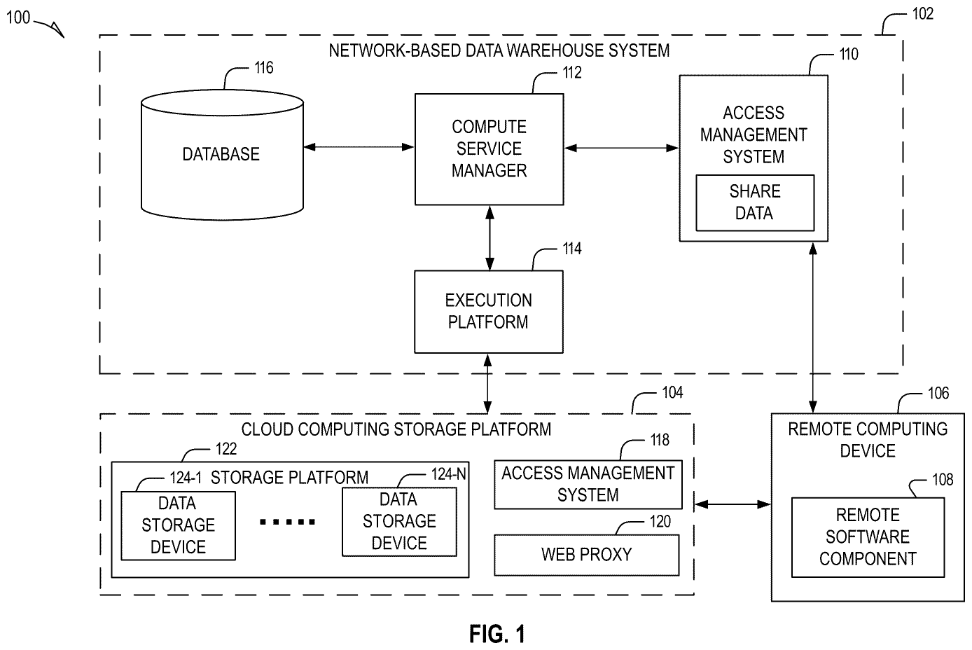

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures, such as streams on shared tables and views, as discussed in further detail below.

The network-based database system 102 comprises an access management system 110, a compute service manager 112, an execution platform (also referred to as XP) 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

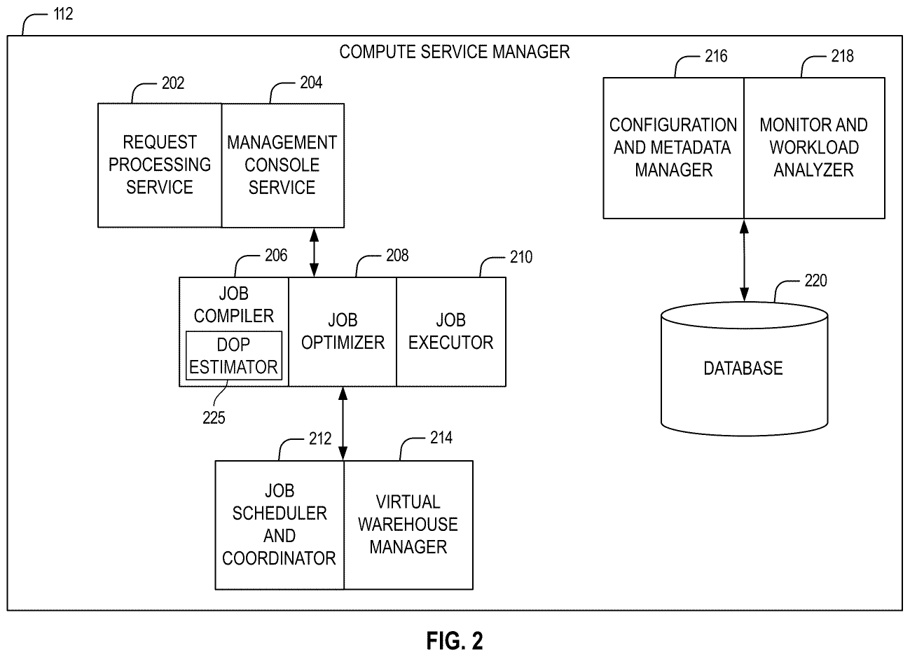

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represents any data storage device within the network-based database system 102. For example, data storage device 220 may represent caches in execution platform 114, storage devices in cloud computing storage platform 104, or any other storage device.

In some example embodiments, the job compiler 206 includes a degree of parallelism (DOP) estimator 225. As described in further detail below, the DOP estimator 225 may generate DOP estimates for tasks associated with a query. The DOP estimates may be generated during compilation.

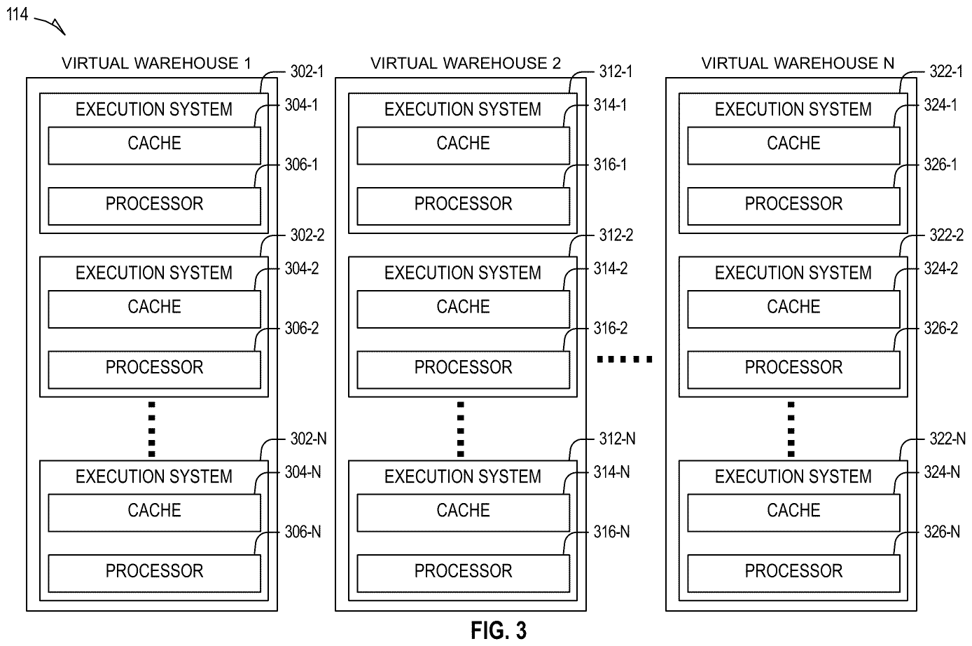

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

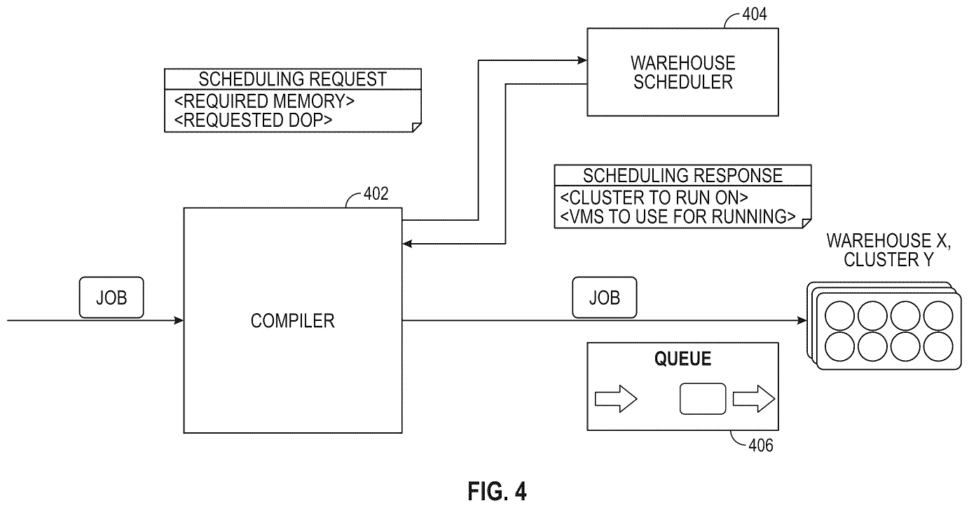

FIG. 4 is a simplified block diagram of a data system architecture for job scheduling in a data system, according to some example embodiments. As described above a user (e.g., computing device 106) transmits a job request (e.g., query) to a compiler 402 (e.g., job compiler 206, job optimizer 208 in compute service manager 112 described above). For example, the job request may be a SQL query. The compiler in the compute service manager may generate a job/query plan, where the query plan may include portions suitable for parallel computing (parallelable portions). The compiler 402 may generate a scheduling request for computing resources to execute the job or workload (collection of jobs). The scheduling request may include a memory component for the computing resources needed to execute the jobs and degree of parallelism (DOP). The scheduling request is transmitted to a warehouse scheduler 404. In some examples, the compiler 402 may transmit the DOP to the warehouse scheduler 404, where the DOP acts like the scheduling request. In some examples, warehouse scheduler 404 may be separate from the compute service manager.

In some other examples, the warehouse scheduler 404 may be provided as a component in the compute service manager. In some example embodiments, the compute service manager may also include a Warehouse Scheduling Service (WSS). The WSS may manage the state of respective virtual warehouses, such as the size and configuration of virtual warehouses. The WSS may communicate with a SMS to request allocation (or deallocations) of computing resources (e.g., execution platforms), as described in further detail below.

The warehouse scheduler 404 (e.g., WSS) can organize a pool of cloud computing resources (e.g., execution platforms 114) to form virtual warehouses, as described above. The virtual warehouses include execution systems with processors and local memories, as described above. The warehouse scheduler 404 can allocate a number of computing resources in a specified virtual warehouse in response to the scheduling request. The warehouse scheduler 404 can transmit the allocation as a scheduling response, which can specify which warehouse and cluster (group of VMs within warehouse) are to be used to process the workload or job. For example, the scheduling response may include the cluster to run on and VMs to use for running.

The compiler 402 may also place the pending job in a queue 406 for the specified warehouse (warehouse x, cluster y). In some examples, the queue 406 may be a first-in-first-out type queue. In some examples, some jobs may be prioritized over other jobs based on types of jobs, service level object (SLO), user, etc. When the pending job reaches the top of queue 406, the job is scheduled to be executed by the specified warehouse (and cluster) based on the scheduling response.

This job execution process can encounter issues with some type of operations, such as stored procedures, user defined functions (UDF), that cannot take advantage of multiple computing resources working in parallel in a warehouse. Stored procedures typically include logic to perform database operations by executing statements. Stored procedures can allow for dynamic creation and execution of statements (e.g., SQL statements). Stored procedures can allow execution of the code with privileges of the role that owns the procedure, rather than with the privileges of the role that runs the procedure. This allows the stored procedure owner to delegate the power to perform specified operations to users who otherwise could not do so themselves. In some examples, stored procedures can automate functions that require multiple statements.

Stored procedures can be in different programming languages. For example, stored procedures can be written in a different language than the programming language used by the data system. For example, the stored procedure can be provided in Java, JavaScript, Python, Scala, etc. Notably, stored procedures cannot be broken down in parallel portions (e.g., tasks) to be executed using a plurality of computing resources (VMs) in parallel. Thus, when a warehouse executes a stored procedure, the warehouse the stored procedure using a single VM, leaving the other VMs in the warehouse underutilized.

Like stored procedures, UDFs are also typically executed by a single VM rather than a group of VMs in parallel. The UDF may be provided in a different programming language (e.g., java, python) than what is used in the data system. The UDF therefore may be treated as untrusted code by the data system and the UDF may be executed in a sandbox. When a warehouse executes a UDF, the warehouse executes the UDF using a single VM, leaving the other VMs in the warehouse underutilized.

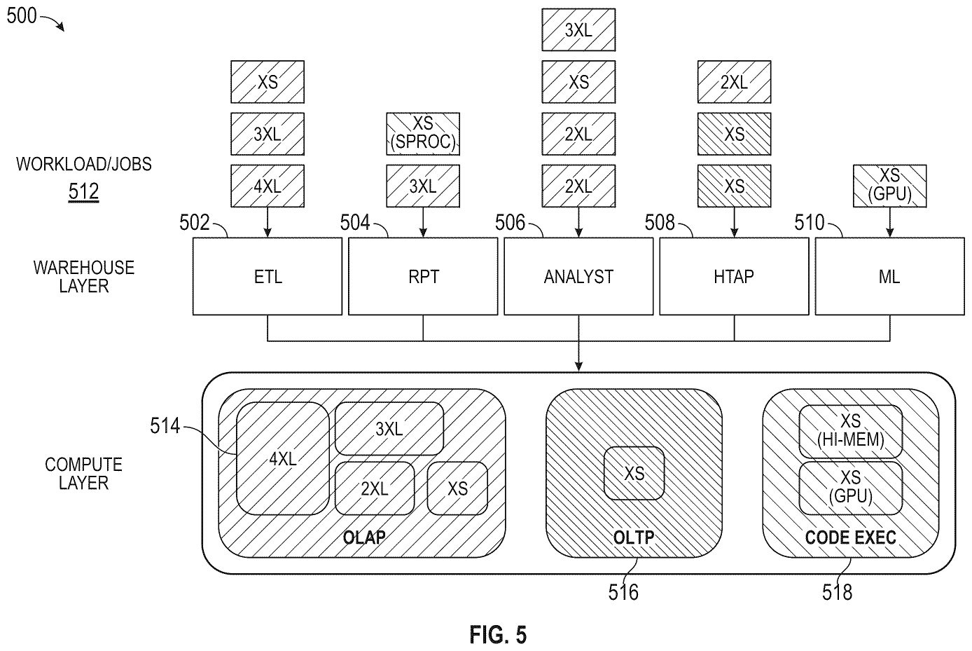

FIG. 5 is a simplified block diagram of an adaptive warehouse framework 500, according to some example embodiments. The adaptive warehouse framework 500 is account specific; that is, the adaptive warehouse framework 500 is provided for a single account. Each account in the data system may have its own corresponding adaptive warehouse framework 500. In some examples, an account may have multiple adaptive warehouse frameworks. For example, an account may have one framework for development and testing and another framework for production traffic.

The adaptive warehouse framework 500 includes a warehouse layer with a plurality of warehouse endpoints 502-510. Each endpoint 502-510 may correspond to a different user-defined operation. For example, endpoint 502 may correspond to extract, transform, and load (ETL) operations. Endpoint 504 may correspond to reporting (RPT) operations. Endpoint 506 may correspond to analyst operations. Endpoint 508 may correspond to hybrid transactional/analytical processing (HTAP) operations. Endpoint 510 may correspond to machine learning (ML) operations. The endpoints may be defined by a user of the account. Workloads/jobs 512 for the account may be inputted into the endpoints 502-510. As described below, usage reports (including costs) may be produced for each endpoint.

A compute layer is provided beneath the warehouse layer and manages compute resources for virtual warehouses defined within an account. As described in further detail below, compute resources can be organized in clusters and can be managed by the compute layer may vary in size and instance type. Cluster operations, such as spin up, spin down, resize, concurrency, etc., are managed by the compute layer.

The compute layer may include different workload regions 514-518 (also referred to as workload pools), where each workload region includes a set of compute resources (see FIG. 3) organized in clusters reserved exclusively for a specific workload type. Workload regions (or workload pools) may provide custom scheduling optimizations for the respective workload type. For example, SQL queries and stored procedures can be optimized to support different levels of bin packing, retry logic or run on different instance types. In this example, workload region 514 corresponds to an online analytical processing (OLAP) region. OLAP jobs may include queries, SQL statements, ETL, and other similar operations.

Workload region 516 may correspond to an online transactional processing (OLTP) region 518. OTLP jobs may include small, light-weight transactional workloads, such as point-fetch type queries (e.g., looking up a particular customer based on customer ID). For OLTP jobs, region 518 may be optimized or aggressive spinup help reduce/eliminate queueing.

Workload region 518 may correspond to a code execution (code exec) region. Code execution region may also be referred to as compute acceleration service region. Code execution jobs may include UDFs, stored procedures, and more complicated operations, such as operations written in a different programming language such as java or python. Code execution jobs may include jobs where operations, such as stored procedure and UDFS, are executed by a single VM.

Each workload region may be configured with custom policies tailored to support the workload type. For example, the OLTP region may include a hyper aggressive cluster spin up policy to avoid queuing jobs (e.g., HTAP type jobs).

Workloads/jobs 512 are submitted to the compute layer via a warehouse endpoint. The warehouse endpoints 502-510 may receive jobs of different sizes (e.g., XS, M, L, XL, etc.) and correspond to different workload regions 514-518. In this example, warehouse endpoint 502 (ETL) receives XS, 3XL, and 4XL jobs, all for warehouse region 514 (OLAP). Warehouse endpoint 504 (RPT) receives a 3XL job for warehouse region 514 (OLAP) and a XS job warehouse region 518 (code exec). Warehouse endpoint 506 (Analyst) receives 2XL, 2XL, XS, and 3XL jobs, all for warehouse region 514 (OLAP). Warehouse endpoint 508 (HTAP) may receive two XS jobs for warehouse region 516 (OLTP) and a 2XL job for warehouse region 514 (OLAP). Warehouse endpoint 510 (ML) receives a XS job for warehouse region 518 (code exec).

The warehouse endpoints submit the jobs to the compute layer, and the compute layer routes the jobs to the appropriate warehouse region and cluster size for execution. For example, OLAP jobs are routed to clusters provisioned in warehouse region 514 (OLAP). OLTP jobs are routed to clusters provisioned in warehouse region 516 (OLTP). Code execution jobs are routed to clusters provisioned in warehouse region 518 (code exec). The compute layer is configured to schedule the jobs on existing clusters. In some examples, if no cluster of the specified size is provisioned, the compute layer may spin up a new cluster of the appropriate size. The compute layer is configured to maximize compute resource utilization across the account.

For example, jobs, such as stored procedures, UDFs, and the like may be routed to the code execution region, which is specifically tailored to handle more complex operations, such as non-SQL compute intensive operations. In some examples, the code execution region may be isolated from other virtual warehouses for security purposes. For example, a virtual warehouse for the account may be provided in a first virtual private cloud (VPC_1) while the compute acceleration service may be provided in a second virtual private cloud (VPC_2).

To handle UDFs and some stored procedures, the VM code execution region may execute the UDF or stored procedure in a sandbox environment. In computer security, a sandbox (e.g., sandbox environment) is a security mechanism for separating running programs, usually to prevent system failures or prevent exploitation of software vulnerabilities. A sandbox can be used to execute untested or untrusted programs or code, possibly from unverified or untrusted third parties, suppliers, users or websites, without risking harm to the host machine or operating system. A sandbox can provide a tightly controlled set of resources for guest programs to run in, such as storage and memory scratch space. Network access, the ability to inspect the host system or read from input devices can be disallowed or restricted. UDFs typically can run in a sandbox environment.

A sandbox process, in an example, is a program that reduces the risk of security breaches by restricting the running environment of untrusted applications using security mechanisms such as namespaces and secure computing modes (e.g., using a system call filter to an executing process and all its descendants, thus reducing the attack surface of the kernel of a given operating system). Moreover, in an example, the sandbox process is a lightweight process in comparison to an execution node process and is optimized (e.g., closely coupled to security mechanisms of a given operating system kernel) to process a database query in a secure manner within the sandbox environment. In some embodiments, the UDF is executed using the UDF server, which is restricted from accessing certain files and file systems. For example, the UDF server and a worker process handling other operations for the continuous auto-ingestion may be provided as different processors on the same machine.

In some embodiments, the sandbox process can utilize a virtual network connection in order to communicate with other components within the subject system. A specific set of rules can be configured for the virtual network connection with respect to other components of the subject system. For example, such rules for the virtual network connection can be configured for a particular UDF to restrict the locations (e.g., particular sites on the Internet or components that the UDF can communicate) that are accessible by operations performed by the UDF. Thus, in this example, the UDF can be denied access to particular network locations or sites on the Internet.

The sandbox process can be understood as providing a constrained computing environment for a process (or processes) within the sandbox, where these constrained processes can be controlled and restricted to limit access to certain computing resources.

Examples of security mechanisms can include the implementation of namespaces in which each respective group of processes executing within the sandbox environment has access to respective computing resources (e.g., process IDs, hostnames, user IDs, file names, names associated with network access, and inter-process communication) that are not accessible to another group of processes (which may have access to a different group of resources not accessible by the former group of processes), other container implementations, and the like. By having the sandbox process execute as a sub-process to the execution node process, in some embodiments, latency in processing a given database query can be substantially reduced (e.g., a reduction in latency by a factor of 10× in some instances) in comparison with other techniques that may utilize a virtual machine solution by itself.

The sandbox process can utilize a sandbox policy to enforce a given security policy. The sandbox policy can be a file with information related to a configuration of the sandbox process and details regarding restrictions, if any, and permissions for accessing and utilizing system resources. Example restrictions can include restrictions to network access, or file system access (e.g., remapping file system to place files in different locations that may not be accessible, other files can be mounted in different locations, and the like). The sandbox process restricts the memory and processor (e.g., CPU) usage of the user code runtime, ensuring that other operations on the same execution node can execute without running out of resources.

As mentioned above, the sandbox process is a sub-process (or separate process) from the execution node process, which in practice means that the sandbox process resides in a separate memory space than the execution node process. In an occurrence of a security breach in connection with the sandbox process (e.g., by errant or malicious code from a given UDF), if arbitrary memory is accessed by a malicious actor, the data or information stored by the execution node process is protected.

The code execution region can include a pool of VMs with different processing capabilities to handle different types of stored procedures, UDFs, etc., such as those including machine-learning components. For example, the compute services can include standard machines (with standard CPU and memory capabilities), higher-memory machines, and graphic processing units (GPU). The scheduler may then assign stored procedures, UDFs, etc., to VMs with the appropriate processing capabilities.

As described above, the adaptive warehouse techniques can allow users to run various workloads (e.g., analytical, transactional, compute-intensive) without creating fixed size warehouses. The data system can automatically allocate the computing resources to run the workload efficiently. However, accurately determining the number of computing resources can encounter technical hurdles.

Next, techniques for estimating the optimal degree of parallelism (DOP) for a workload, such as a query, at compile time are described. As described in further detail below, the DOP estimation may be performed within the compiler with no input from the warehouse scheduler. In some embodiments, the DOP estimation may not be dependent on warehouse limits or the current state of warehouse (e.g., active clusters and queries). The DOP estimate may be transmitted to the warehouse scheduler at the query execution step. The warehouse scheduler may then select an actual execution DOP with additional consideration of existing cluster configurations and user specified limits, as described above.

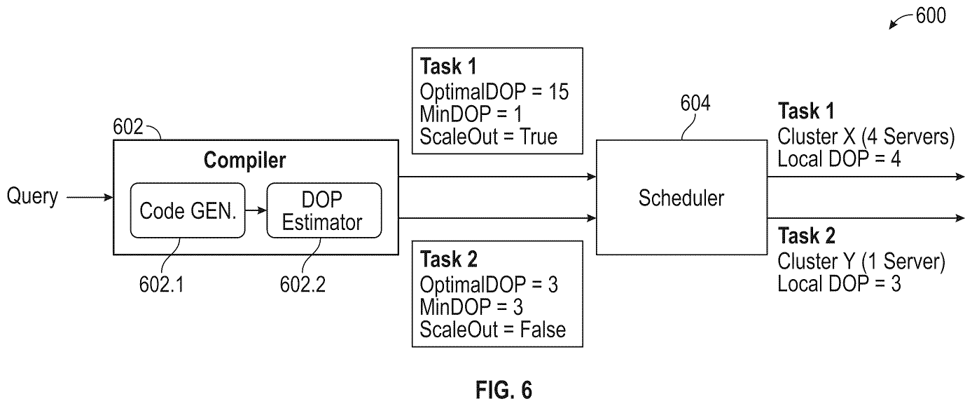

FIG. 6 is a simplified block diagram of framework 600 for DOP estimation, according to some example embodiments. The framework 600 includes a compiler 602 and a scheduler 604. The compiler 602 may be provided in a compute service manager 112, as described above, such as job compiler 206. The compiler 602 includes a code generation unit 602.1 and a DOP estimator 602.2. The compiler 602 may receive queries.

The code generation unit 602.1 may generate an execution plan to execute respective queries. The execution plan may include operators and links connecting the operators. As mentioned above, the code generation unit 602.1 may parse a query (or job) into multiple discrete tasks and generates the execution code for each of the multiple discrete tasks. The execution plan may be optimized based on optimization rules. The rules may be directed to pruning or constant folding one or more operators based on predicate properties, predicate simplification, filter pushdown, eliminating unnecessary grouping or aggregation, and/or other suitable rules.

The DOP estimator 602.2 may generate DOP estimates of the different tasks associated with a query. For each task, the DOP estimator 602.2 may generate an optimal DOP value, a minimum DOP value, and a scale out value in some examples. The optimal DOP value may correspond to the optimal number of threads or workers to execute the respective task. The minimum DOP value may correspond to a minimum number of threads or workers to execute the task. For example, using fewer than the minimum DOP value may risk running out of memory in the computing resources while executing the respective task or lead to significant degradation of performance. The scale out value may indicate whether the task may be scaled out linearly. The scale out value may be used by the scheduler 604 to determine whether the DOP can be increased beyond the optimal DOP value specified if computing resources are available.

In the example shown in FIG. 6, for Task 1, an optimal DOP value of 15 is determined as well as a minimum DOP value of 1 and a scaling out value of true. For Task 2, an optimal DOP value of 3 is determined as well as a minimum DOP value of 3 and scaling out value of false.

The execution plan and the DOP estimates (e.g., optimal DOP value, minimum DOP value, scale out value) may be transmitted from the compiler 602 to the scheduler 604. The scheduler 604 may then schedule the respective tasks to be executed by the assigned clusters. The scheduler 604 may set a local DOP for the tasks based on the DOP estimates and current availability of computing resources, as described above (warehouse scheduler). In the example shown in FIG. 6, Task 1 has a local DOP value of 4 set by the scheduler and is scheduled to be executed by cluster X, which includes 4 servers (e.g., threads or workers). Task 2 may be scheduled on a different cluster Y (1 server) with a local DOP value 3 because Task 2 is marked as scaling out value of false.

Inaccurate estimates of DOPs can have adverse impacts on the performance of the data system. For example, overestimating the DOP can lead to underutilization of clusters and can introduce additional run-time overhead, reducing overall execution efficiency and execution time of queries. Underestimating the DOP can lead to query failures or slow query execution times.

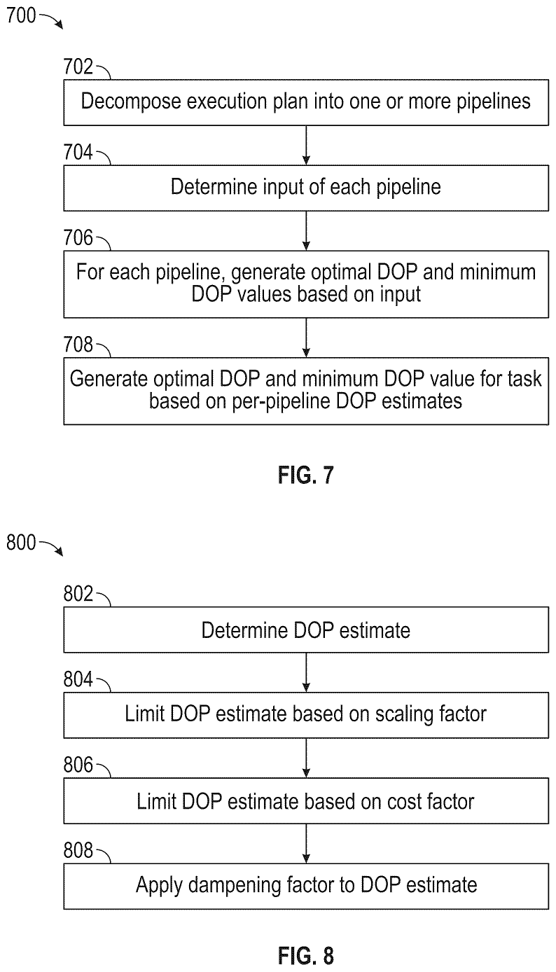

FIG. 7 is a flow diagram of a method 700 for estimating DOP for a query, according to some example embodiments. In some examples, method 700 may be executed by the DOP estimator 602.2 as described above. Method 700 may be performed after code generation but before execution. A query may be received by the network-based data system, as described herein. An execution plan for the query (or task) may be generated in code generation.

At operation 702, an execution plan is decomposed into one or more execution pipelines. A pipeline may include a sequence of connected row set operators (RSOs) that starts and ends in a leaf operator (e.g., table scan, external scan, row generator), a pipeline breaker (buffer, aggregation, sort) or in a result operator. RSOs in a pipeline may be connected using links, such as redistributing links.

At operation 704, input of each pipeline is determined. In some examples, the input may include input bytes, pipeline (sequence) throughput, and pipeline (sequence) memory usage.

Input bytes refer to the number of bytes processed by the pipeline. Input bytes may be determined by summing the expected bytes produced by each table scan operator in the pipeline. The expected bytes produced by each table scan operator may be computed by multiplying cardinality estimates by the row size for the operator. Heuristics may be added around run-time filters that can account for significant data reduction.

Pipeline throughput refers to how many bytes or rows per second can be processed by the pipeline assuming that the pipeline runs on a single core. The computation may assume a default fixed throughput irrespective of the pipeline shape and then makes adjustments based on the operators in the pipeline. For example, compute-intensive expressions, UDFs, operators creating additional work (e.g., exploding joins), operators spilling to disk (e.g., join, sort), and DML operations can affect pipeline throughput and are accounted for in the pipeline throughput estimation.

Pipeline memory usage may refer to the amount of memory used by the threads or workers for the pipeline. As described herein, memory usage can provide a minimal amount of computing resources.

At operation 706, generate per-pipeline optimal DOP and minimum DOP values based on the input. In some examples, the optimal DOP value for a pipeline may be generated by dividing the input bytes by pipeline throughput to compute the single-core execution latency of the pipeline. A target execution time may be set. The system may then compute what DOP value will bring down the execution time to the target execution time. For example, if the single-core execution time of the pipeline is estimated to be 10 seconds and a target execution time is set at 1 second, then the optimal DOP equals 10.

In some examples, pipeline duration may be calculated using the following formula:

$$Pipeline Duration = \frac{max ( NDV * TableScan \cdot RowSize )}{Pipeline Throughput} ,$$

where NDV is the number of distinct values. NDV may be obtained from the expression properties (EP) of the tables. The optimal DOP may be calculated using the following formula:

$$optimalDOP = \frac{Pipeline Duration}{target execution time}$$

In some examples, the minimum DOP value for a pipeline may be generated based on the following formula:

$$\frac{Mv}{B - Mf} \leq min DOP ,$$

where Mv is a variable portion of the pipeline memory usage, Mf is the fixed portion of the pipeline memory usage, and B is the fixed per-work memory budget.

At operation 708, the optimal DOP and minimum DOP values for the task is generated based on the per-pipeline optimal DOP and minimum DOP values. For example, the maximum optimal DOP value across the respective pipelines may be selected as the optimal DOP value for the task to account for the most resource-expensive pipeline in the task to ensure that the target execution time is met. Likewise, for example, the highest minimum DOP value across the respective pipelines in the task may be selected as the minimum DOP value for the task to ensure that all pipelines fit in the target memory budget.

Method 700 may be performed for each task associated with a query, as described above. The DOP estimates may be sent to a scheduler, which can then schedule the tasks for execution by an appropriate cluster, for example, in an adaptive warehouse framework as described above.

The DOP estimates may be further refined based on other factors. FIG. 8 is a flow diagram of a method 800 for refining a DOP estimate, according to some example embodiments. In some examples, method 800 may be executed by the DOP estimator 602.2 as described above.

At operation 802, a DOP estimate is determined. The DOP estimate may be based on pipeline throughput and/or duration as described above. For example, an optimal DOP value may be determined using the techniques described above (e.g., method 700 described above with reference to FIG. 7).

At operation 804, the DOP estimate is limited based on a scaling out factor. The scaling out factor may correspond to a number of independent work units, such as a number of files, rows, etc., to be read. For example, the DOP estimator may determine the number of files (or rows) to be read based on the execution plan. The DOP estimator may then limit or cap the optimal DOP value based on the number of files (or rows). For example, if the DOP estimator determined an optimal DOP value of 10 threads or workers but also determined that only two files are to be read in the execution plan, the DOP estimator may cap the optimal DOP value at 2 threads or workers. That is because a file can be read by only a single thread or worker at a time and therefore a maximum of 2 threads or workers can read the two files and the other 8 threads of workers of the initial 10 DOP estimate would be wasted.

At operation 806, the DOP estimate is limited based on a cost factor. The cost factor may be related to the fixed cost amount for setting up computing resources, such as threads or workers. Let's consider the example of large query plans with a small number of pipelines. In these large query plans, most of the time is spent on performing fixed time operations, such as starting the pipeline, scanning a single file, terminating the pipeline, and synchronizing afterwards. These fixed time operations do not generally get faster with the addition of DOP (or more resources), but instead may actually get slower. To protect against this fixed time cost factor, a maximum cost limit may be applied to the DOP estimate based on the extra cost that goes towards the fixed cost portions of the execution plan of the query.

For example, the DOP estimate (d) may be limited based on the cost factor using the following equation:

$$d = \frac{t ( 2 s - 1 )}{f ( 1 - s )} ,$$

where t is the time for 1 DOP duration, fix is the total fixed time, and s is a desired performance factor. The performance factor may be set by a user or system, such as 90% performance, 80% performance, etc.

At operation 808, a dampening factor is applied to the DOP estimate. The dampening factor may be set based on a DOP target set by a user or system for a specific level of parallelism or warehouse size. For example, the output DOP estimate may be determined using the following equation:

$$dop\_out = \sqrt{d * dop\_target} ,$$

where d is the DOP estimate and dop_target is the DOP target value set by the user or system.

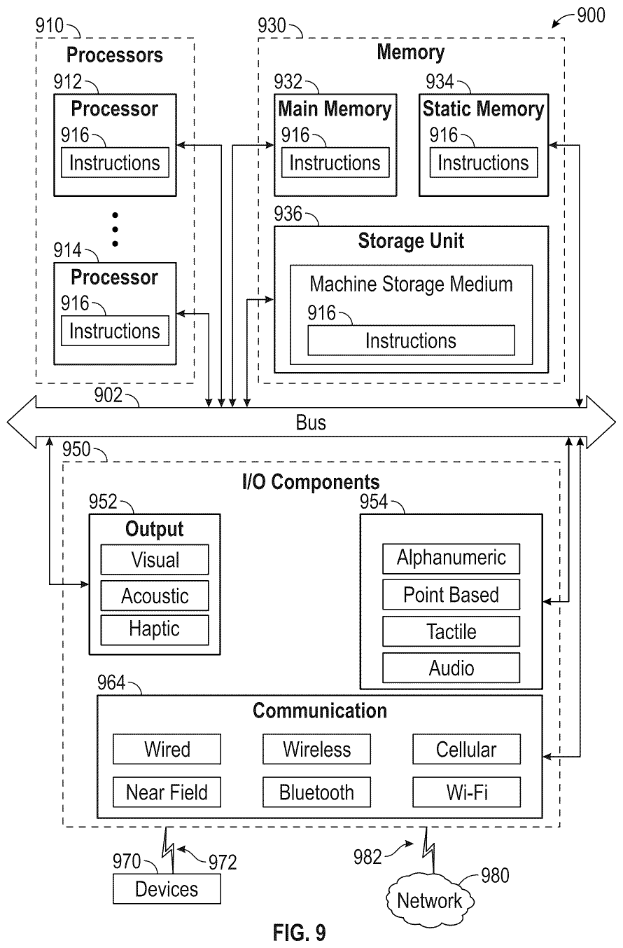

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute any one or more operations of any one or more of the methods described herein. As another example, the instructions 916 may cause the machine 900 to implement portions of the data flows described herein. In this way, the instructions 916 transform a general, non-programmed machine into a particular machine 900 (e.g., the remote computing device 106, the access management system 110, the compute service manager 112, the execution platform 114, the access management system 118, the Web proxy 120) that is specially configured to carry out any one of the described and illustrated functions in the manner described herein.

In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 includes processors 910, memory 930, and input/output (I/O) components 950 configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors 910 that may comprise two or more independent processors (sometimes referred to as “cores”) that may execute instructions 916 contemporaneously. Although FIG. 9 shows multiple processors 910, the machine 900 may include a single processor with a single core, a single processor with multiple cores (e.g., a multi-core processor), multiple processors with a single core, multiple processors with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 include components to receive input, provide output, produce output, transmit information, exchange information, capture measurements, and so on. The specific I/O components 950 that are included in a particular machine 900 will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, and other communication components to provide communication via other modalities. The devices 970 may be another machine or any of a wide variety of peripheral devices (e.g., a peripheral device coupled via a universal serial bus (USB)). For example, as noted above, the machine 900 may correspond to any one of the remote computing device 106, the access management system 118, the compute service manager 112, the execution platform 114, the Web proxy 120, and the devices 970 may include any other of these systems and devices.

The various memories (e.g., 930, 932, 934, and/or memory of the processor(s) 910 and/or the storage unit 936) may store one or more sets of instructions 916 and data structures (e.g., software) embodying or utilized by any one or more of the methodologies or functions described herein. These instructions 916, when executed by the processor(s) 910, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: receiving, by a network-based data system, a query; generating an execution plan to execute the query, the execution plan comprising a plurality of operators and links; decomposing the execution plan into a plurality of sequences of connected operators of the plurality of operators; for each sequence of the plurality of sequences: determining a set of input values, and generating a per-sequence optimal degree of parallelism (DOP) value and a per-sequence minimum DOP value based on the set of input values for the respective sequence; and generating an optimal DOP value and a minimum DOP value for the query based on the per-sequence optimal DOP values and per-sequence minimum DOP values for the plurality of sequences.

Example 2. The method of example 1, wherein the input values comprise input bytes, sequence throughput, and sequence memory usage.

Example 3. The method of any of examples 1-2, wherein generating the per-sequence optimal DOP value comprises: dividing the input bytes by sequence throughput to determine a single core execution time of the sequence; setting a target execution time; and determining the per-sequence optimal DOP based on the single core execution time and the target execution time.

Example 4. The method of any of examples 1-3, wherein each sequence starts and ends with a respective leaf operator, sequence breaker, or result operator.

Example 5. The method of any of examples 1-4, further comprising: limiting the optimal DOP value based on a number of independent work units in the execution plan.

Example 6. The method of any of examples 1-5, wherein each independent work unit of the number of independent work units comprises a respective file.

Example 7. The method of any of examples 1-6, further comprising: limiting the optimal DOP value based on a cost factor.

Example 8. The method of any of examples 1-7, wherein the cost factor comprises a fixed cost amount for setting up computing resources.

Example 9. The method of any of examples 1-8, further comprising: applying a dampening factor to the optimal DOP value, wherein the dampening factor is based on a DOP target set by a user.

Example 10. A system comprising: one or more processors of a machine; and a memory storing instructions that, when executed by the one or more processors, cause the machine to perform operations implementing any one of example methods 1 to 9.

Example 11. A machine-readable storage device embodying instructions that, when executed by a machine, cause the machine to perform operations implementing any one of example methods 1 to 9.

1. A method comprising:
receiving, by a network-based data system, a query;
generating an execution plan to execute the query, the execution plan comprising a plurality of operators and links;
decomposing the execution plan into a plurality of sequences of connected operators of the plurality of operators;
for each sequence of the plurality of sequences:
determining a set of input values, and
generating a per-sequence optimal degree of parallelism (DOP) value and a per-sequence minimum DOP value based on the set of input values for the respective sequence;
generating an optimal DOP value for the query by selecting a maximum optimal DOP value across the respective per-sequence optimal DOP values for the plurality of sequences to account for a most resource-expensive sequence; and
generating a minimum DOP value for the query by selecting a highest minimum DOP value across the respective per-sequence minimum DOP values for the plurality of sequences to ensure that all sequences fit in a target memory budget.

2. The method of claim 1, wherein the input values comprise input bytes, sequence throughput, and sequence memory usage.

3. The method of claim 2, wherein generating the per-sequence optimal DOP value comprises:
dividing the input bytes by sequence throughput to determine a single core execution time of the sequence;
setting a target execution time; and
determining the per-sequence optimal DOP based on the single core execution time and the target execution time.

4. The method of claim 1, wherein each sequence starts and ends with a respective leaf operator, sequence breaker, or result operator.

5. The method of claim 1, further comprising:
limiting the optimal DOP value based on a number of independent work units in the execution plan.

6. The method of claim 5, wherein each independent work unit of the number of independent work units comprises a respective file.

7. The method of claim 1, further comprising:
limiting the optimal DOP value based on a cost factor.

8. The method of claim 7, wherein the cost factor comprises a fixed cost amount for setting up computing resources.

9. The method of claim 1, further comprising:
applying a dampening factor to the optimal DOP value, wherein the dampening factor is based on a DOP target set by a user.

10. A system comprising:
at least one hardware processor; and
at least one memory storing instructions that, when executed by the at least one hardware processor, cause the at least one hardware processor to perform operations comprising:
receiving, by a network-based data system, a query;
generating an execution plan to execute the query, the execution plan comprising a plurality of operators and links;
decomposing the execution plan into a plurality of sequences of connected operators of the plurality of operators;
for each sequence of the plurality of sequences:
determining a set of input values, and
generating a per-sequence optimal degree of parallelism (DOP) value and a per-sequence minimum DOP value based on the set of input values for the respective sequence;
generating an optimal DOP value for the query by selecting a maximum optimal DOP value across the respective per-sequence optimal DOP values for the plurality of sequences to account for a most resource-expensive sequence; and
generating a minimum DOP value for the query by selecting a highest minimum DOP value across the respective per-sequence minimum DOP values for the plurality of sequences to ensure that all sequences fit in a target memory budget.

11. The system of claim 10, wherein the input values comprise input bytes, sequence throughput, and sequence memory usage.

12. The system of claim 11, wherein generating the per-sequence optimal DOP value comprises:
dividing the input bytes by sequence throughput to determine a single core execution time of the sequence;
setting a target execution time; and
determining the per-sequence optimal DOP based on the single core execution time and the target execution time.

13. The system of claim 10, wherein each sequence starts and ends with a respective leaf operator, sequence breaker, or result operator.

14. The system of claim 10, the operations further comprising:
limiting the optimal DOP value based on a number of independent work units in the execution plan.

15. The system of claim 14, wherein each independent work unit of the number of independent work units comprises a respective file.

16. The system of claim 10, the operations further comprising:
limiting the optimal DOP value based on a cost factor.

17. The system of claim 16, wherein the cost factor comprises a fixed cost amount for setting up computing resources.

18. The system of claim 10, the operations further comprising:
applying a dampening factor to the optimal DOP value, wherein the dampening factor is based on a DOP target set by a user.

19. A machine-storage medium embodying instructions that, when executed by a machine, cause the machine to perform operations comprising:
receiving, by a network-based data system, a query;
generating an execution plan to execute the query, the execution plan comprising a plurality of operators and links;
decomposing the execution plan into a plurality of sequences of connected operators of the plurality of operators;
for each sequence of the plurality of sequences:
determining a set of input values, and
generating a per-sequence optimal degree of parallelism (DOP) value and a per-sequence minimum DOP value based on the set of input values for the respective sequence;
generating an optimal DOP value for the query by selecting a maximum optimal DOP value across the respective per-sequence optimal DOP values for the plurality of sequences to account for a most resource-expensive sequence; and
generating a minimum DOP value for the query by selecting a highest minimum DOP value across the respective per-sequence minimum DOP values for the plurality of sequences to ensure that all sequences fit in a target memory budget.

20. The machine-storage medium of claim 19, wherein the input values comprise input bytes, sequence throughput, and sequence memory usage, and
wherein generating the per-sequence optimal DOP value comprises:
dividing the input bytes by sequence throughput to determine a single core execution time of the sequence;
setting a target execution time; and
determining the per-sequence optimal DOP based on the single core execution time and the target execution time.
